(19) United States
(12) Patent Application Publication
(10) Pub. No.: US 2013/0223544 A1
(43) Pub. Date: Aug. 29, 2013

(54) SYSTEM AND METHOD FOR EFFICIENT FREQUENCY ESTIMATION IN BURST-MODE COMMUNICATION

(71) Applicant: Neal Becker, Frederick, MD (US)

(72) Inventor: Neal Becker, Frederick, MD (US)

(21) Appl. No.: 13/407,495

(22) Filed: Feb. 28, 2012

(51) Int. Cl. H04L 27/00; H04B 1/06; H04B 1/02

(52) U.S. Cl. 375/259; 375/295; 375/316; 375/343

(57) ABSTRACT

Aspects of the invention provide a method of introducing pilot symbols for synchronization that minimizes overhead while allowing for a large frequency uncertainty by inserting the pilot groups non-periodically in burst communication systems. The pilot sequence could be used for establishing all synchronization, including timing, frequency and phase, or, alternatively, it could be used only for carrier phase and frequency estimation with some other means used for establishing start-of-burst timing.

### BACKGROUND

The present application relates to the field of digital communication systems, in particular, frequency estimation techniques in burst mode communication systems.

In typical burst mode communication systems, a transmitter transmits burst mode signals at a certain frequency, phase and timing, which is received by a receiver through a communication channel. Typically, the burst mode signals arc modulated using a carrier frequency at the transmitter before transmitting it to the receiver. The receiver must demodulate the received signals to remove the effect of the carrier. The frequency conversion at the transmitter and the receiver are achieved by means of oscillators operating at certain frequency and initial phase. Oscillator instability and channel noise among other factors degrade the end-to-end performance of the information transfer between the transmitter and the receiver.

In coherent systems, the receiver carrier is phase locked with the carrier at the transmitter. In burst mode communication systems using coherent detection, it is necessary to perform four functions to receive each burst. First, the start of the burst must be detected. Next, frequency, symbol timing and phase estimates need to be established.

Typically, a known Unique Word (UW) pattern is inserted at the start of the burst by the transmitter. This pattern is detected at the receiver using correlation and thresholding in some cases. Frequency and symbol timings usually vary slowly with respect to a burst time, and are thus considered random scalar values for each burst. Typically, phase is not coherent through a burst but varies due to various factors such as oscillator stability and fading channels. Thus the phase is considered a random process that has to be estimated throughout the burst. A conventional communication system is discussed below using FIG. 1.

FIG. 1 illustrates a conventional communication system 100.

As illustrated in the figure, conventional communication system 100 includes a transmitter 102, a receiver 104 and a communication channel 106.

Transmitter 102 transmits a tx burst signal 108 to receiver 104 via communication channel 106. Due to the noise introduced by communication channel 106, receiver 104 receives a noisy rx burst signal 110. Some non-limiting examples of channel noise include atmospheric noise, solar noise, cosmic noise, thermal noise, white noise, Gaussian noise or noise due to the Doppler effect. Receiver 104 must process the noisy rx burst signal 110 in order to recover the information transmitted in tx burst signal 108. Transmitter 102 and receiver 104 arc discussed in detail with the help of FIGS. 2-3.

FIG. 2 illustrates a block diagram for transmitter 102.

As illustrated in the figure, transmitter 200 includes an encoder 202, a bit to symbols convertor 204, and a modulator 206.

Encoder 202 is operable to receive a bit stream 208 and to perform encoding. As an example, encoder 202 is an FEC (Forward Error Correction) encoder, where extra bits are added to bit stream 208 to allow for error correction at the receiver.

Bit to symbols convertor 204 receives an encoded bits signal 210 and converts it to a data symbols signal 212 in preparation for modulation. For example, QPSK modulation uses 2 bits/symbol. In this case, every 2 consecutive bits out of the encoder could be grouped to form each QPSK symbol.

Modulator 206 modulates data symbols signal 212 using a known modulation scheme to provide tx burst signal 108 ready for transmission to channel 106. Modulator 206 uses any known modulation scheme based on amplitude, phase or frequency of the carrier signal. In some cases, modulator 206 inserts a known UW pattern at the start of tx burst signal 108 to provide a mechanism for receiver 104 to synchronize with the burst.

Receiver 104 receives tx burst signal 108 via channel 106, which is further explained with the help of FIG. 3.

FIG. 3 illustrates a block diagram for receiver 104.

As illustrated in the figure, receiver 104 includes a correlator 302, a demodulator 304, and a decoder 306. Receiver 104 uses correlation to determine when a received signal has matched an expected signal and then uses the timing information to decode and process received information from a received signal.

Correlator 302 receives rx burst signal 110 via channel 106 transmitted by transmitter 102. Correlator 302 detects the start of the burst by comparing a predetermined UW pattern with the received rx burst signal 110.

Demodulator 304 receives a correlated data signal 308 and performs demodulation to establish a timing and frequency estimate on the received data. The demodulator receives signal parameter estimates from the correlator, together with the original received input signal.

Decoder 306 receives a demodulated data signal 310 and performs decoding to recover the original bit stream.

As discussed earlier, receiver 104 uses correlation to detect the start of the burst from the UW inserted by transmitter 102 in burst signal 108. In some cases (depending on modulation type, channel conditions), it is useful to introduce known pilot symbols into the transmitted streams. These known pilot symbols can be used for frequency and phase estimation. In some cases it would be helpful to have both a UW for start of burst detection as well as pilot symbols for phase estimation.

In some cases the functions of UW and pilot symbols could be combined to minimize overhead. The pilot symbols can be used for UW detection. For example, groups of consecutive symbols can be coherently combined. Typically the carrier phase will not be coherent from one group of the pilot symbols to the next. In those cases, the groups of symbols cannot be coherently combined for UW detection. But the groups can be incoherently combined for UW detection (with some loss in detection performance). As long as the signal to noise ratio is high enough after the consecutive symbols are coherently combined, the loss due to non-coherent combining of the results will be minimal.

Any known symbol can be used for frequency estimation, including UW and/or pilot symbols. A straightforward and near maximum-likelihood (ML) approach would be to compute the Discrete Fourier Transform (DFT) of the known symbols after removing modulation (multiply by the complex conjugate of the known transmit signal), then find the frequency that maximizes the magnitude-squared of the DFT output. That is, compute:

Fₙ=Σrᵢxᵢ*e^{2πiΔ}_{f}ⁿ, (1)

where rᵢ are the received signal samples, xᵢ are the transmit signal samples for the known parts and zero for the unknown parts, Δ_{f} is some chosen frequency step size. The frequency can be estimated by finding the value of n that maximizes |Fₙ|. In some cases, interpolation could be used for the maximization.

The frequency estimation technique is conventionally performed by inserting known (pilot) symbols periodically, i.e., groups of m consecutive symbols inserted periodically, say every n transmitted symbols. This is further explained with the help of FIG. 4.

FIG. 4 illustrates a communication protocol 400 for communication system 100.

As illustrated in the figure, communication protocol 400 includes a frame 404 sampled on an x-axis 402, which represents time in seconds.

Frame 404 includes a UW 406 and a payload 410. Unique word provides a mechanism for receiver 104 to synchronize with frame 404. Payload 410 includes data and information desired by transmitter 102 to be received and processed by receiver 104. Each UW and payload is made up of a plurality of symbols, denoted as ‘S’, however, for illustrative purposes, only few symbols are shown. In conventional cases, a periodic known sequence is inserted in burst signal 108 to help with the initial frequency estimate at receiver 104, as denoted by pilot symbols ‘PS’.

UW 406 includes a symbol 410, a symbol 412, a symbol 414, a symbol 416, a pilot symbol 418, a symbol 420, a symbol 422, a symbol 424, and a pilot symbol 426. Payload 408 includes a symbol 428, a symbol 430, a symbol 432, a symbol 434, a pilot symbol 436, a symbol 438, a symbol 440, a symbol 442, a symbol 444, a pilot symbol 446, a symbol 448, a symbol 450, a pilot symbol 452, and a symbol 454.

Note that in the example communication protocol 400, pilot symbols are inserted periodically, i.e., one pilot symbol is inserted after every four symbols. As illustrated in FIG. 4, for UW 106 pilot symbol 418 is inserted after symbol 410, symbol 412, symbol 414, and symbol 416. Similarly, for payload 408, pilot symbol 436 is inserted after symbol 428, symbol 430, symbol 432, and symbol 434.

As discussed with reference to FIG. 4, inserting m consecutive symbols periodically for every n transmitted symbols could give good performance under some conditions. If the frequency uncertainty is large (the range of possible Δ_{f}) compared to the time interval between groups of pilot symbols nT, where T is the symbol duration, then there could be false detections. Specifically, there could be (depending on signal to noise ratio) a high probability of detecting one of the false peaks, therefore, resulting in incorrect frequency estimation. This is explained by considering a Fast Fourier Transform (FFT) of a known pilot sequence with the help of FIG. 5.

FIG. 5 illustrates a spectrum 500 for a periodic pilot sequence.

Spectrum 500 includes an x-axis 502, which represents the frequency and a y-axis 504, which represents magnitude in dB.

Spectrum 500 shows the FFT of a periodic sequence, for example, similar to the one discussed with reference to FIG. 4. It is obvious from FIG. 5 that there are many peaks to spectrum 500, as shown by 506. Depending on signal-to-noise ratio, there is a high probability of detecting one of the false peaks and hence establishing wrong frequency estimation. Based on spectrum 500 for a periodic pilot sequence, it can be concluded that efficient frequency estimation is not always possible for a burst sequence including periodically inserted pilot symbols.

One possible solution to avoid detecting false peaks is to insert pilot symbols frequently (choose n small enough). However, this solution increases synchronization overhead due to insertion of more wasteful symbols.

What is needed is a method for efficient frequency estimation in burst mode communication systems.

### BRIEF SUMMARY

The present invention provides a method for efficient frequency estimation in burst mode communication systems.

In accordance with an aspect of the present invention, a method is provided for communicating in a burst mode communication system having a transmitter and a receiver. The transmitter can transmit output data at a transmission frequency, wherein the output data is based on a stream of information data with pilot symbols interspersed therein. The receiver can receive the output data from the transmitter and can estimate the transmission frequency based on the pilot symbols. The method includes: receiving, via an input portion, the stream of information data; receiving, via an inserting portion, the stream of information data from the input portion; inserting, via the inserting portion, the pilot symbols into the stream of data at non-periodic intervals to create the output data; and providing, via output portion, the output data to the transmitter.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which arc incorporated in and form a part of the specification, illustrate an exemplary embodiment of the present invention and, together with the description, serve to explain the principles of the invention. In the drawings:

FIG. 1 illustrates a conventional communication system 100;

FIG. 2 illustrates a block diagram for transmitter 102;

FIG. 3 illustrates a block diagram for receiver 104;

FIG. 4 illustrates a communication protocol 400 for communication system 100;

FIG. 5 illustrates a spectrum 500 for a periodic pilot sequence;

FIG. 6 illustrates a modulator in accordance with an aspect of the invention;

FIG. 7 illustrates a non-periodic pilot sequence for a burst signal in accordance with an aspect of the invention;

FIG. 8 illustrates a demodulator in accordance with an aspect of the invention;

FIG. 9 illustrates an example embodiment of a distinguishing portion in accordance with an aspect of the invention;

FIG. 10 illustrates a spectrum 1000 for a non-periodic pilot sequence in accordance with an aspect of the invention; and

FIG. 11 illustrates a magnified spectrum 1000 in accordance with an aspect of the invention.

### DETAILED DESCRIPTION

A system and method is provided for efficient frequency estimation in burst mode communication systems by introducing pilot symbols non-periodically for synchronization. Aspects of the invention minimize overhead while allowing for large frequency uncertainty. In one embodiment, start of the burst is detected using a separate UW, while the carrier phase and frequency estimation is performed using the pilot sequence. In another embodiment, the pilot sequence could be used for establishing all synchronization, including timing, frequency and phase.

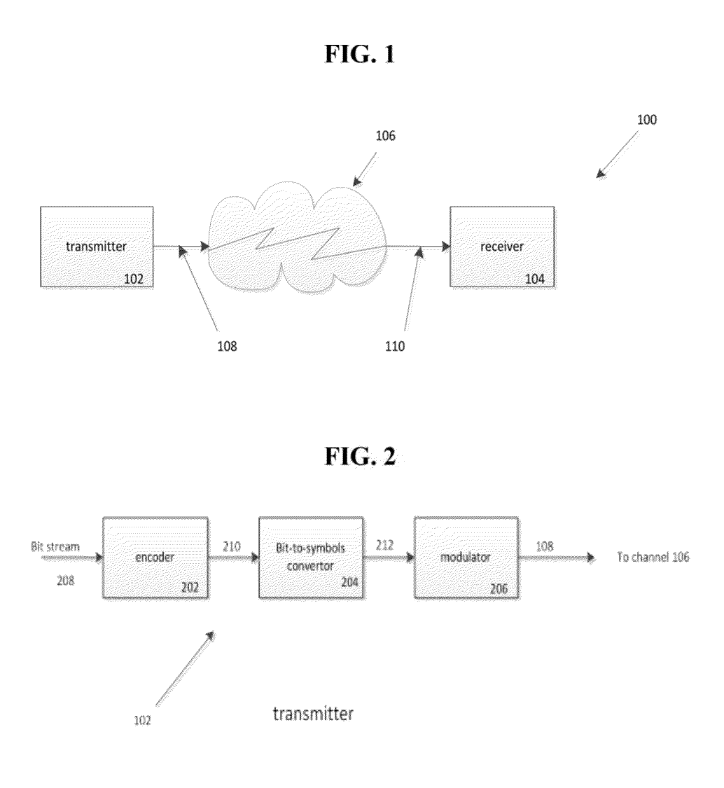

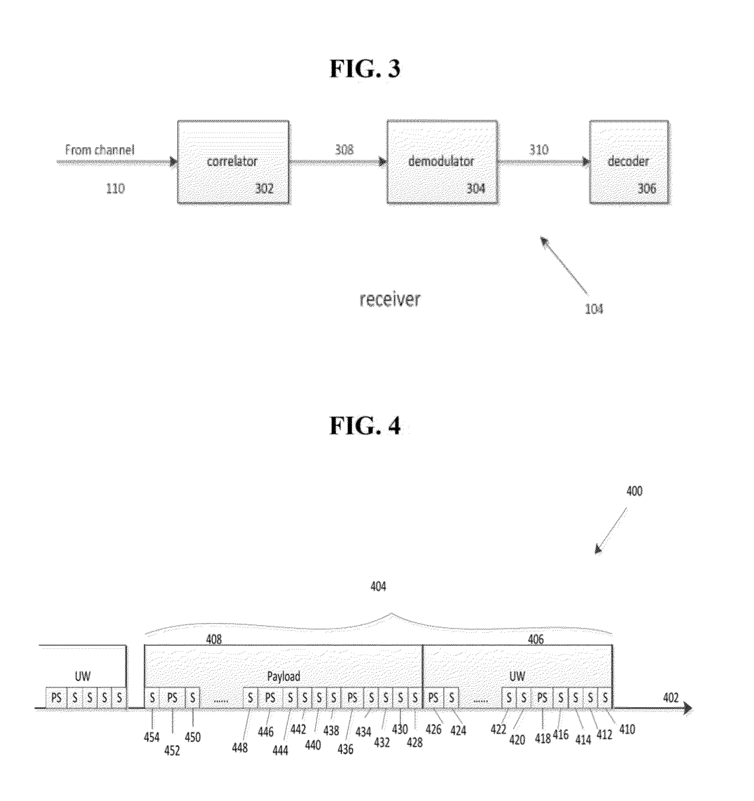

As discussed with reference to FIG. 1, transmitter 102 transmits burst mode signals at a certain frequency, phase and timing, which is received by receiver 104 through communication channel 106. Receiver 104 must detect start of the burst before establishing other parameters like frequency, timing and phase in order to recover the transmitted information. In one embodiment, receiver 104 uses correlation to detect the start of the burst. Since the burst may arrive with a frequency offset, receiver 104 needs to make an initial estimate of the frequency before establishing timing and phase estimation. Any known method for timing and phase estimation may be used.

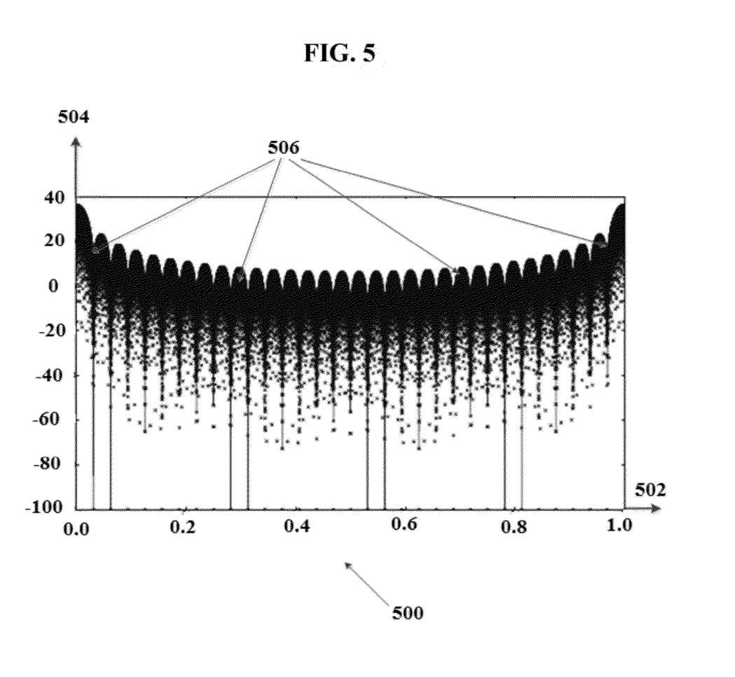

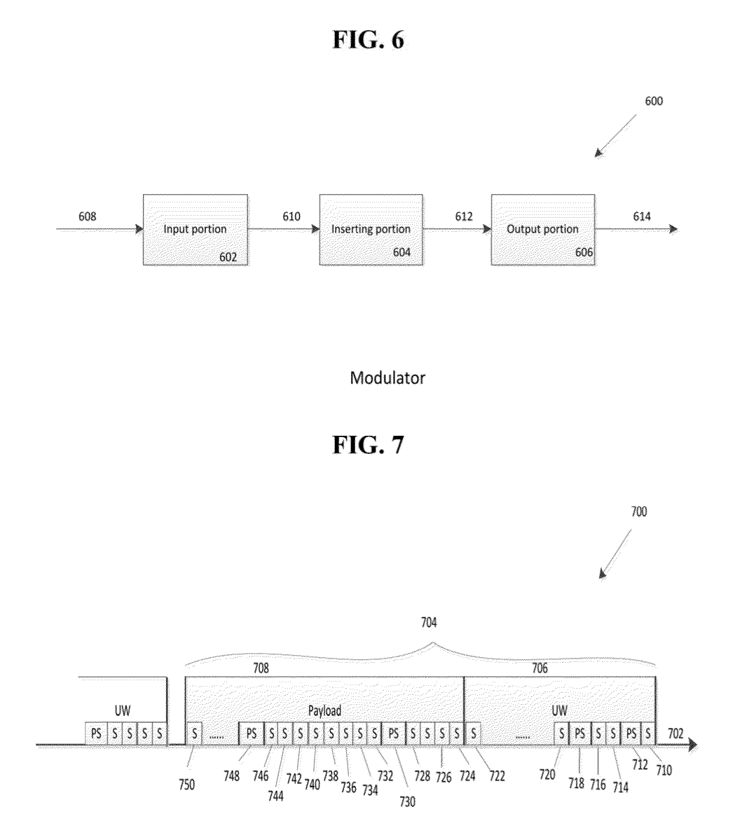

The present application deals with frequency estimation techniques once a burst has been detected. As discussed earlier with reference to FIGS. 4-5, inserting pilot symbols periodically in a burst sequence for frequency estimation does not provide the most optimum solution. Aspects of the invention provide a method to insert pilot symbols in a non-periodic sequence, which is discussed below using a modulator and demodulator with the help of FIGS. 6-7.

FIG. 6 illustrates a modulator in accordance with an aspect of the invention.

As illustrated in the figure, a modulator 600 includes an input portion 602, an inserting portion 602, and an output portion 606. In this example, input portion 602, inserting portion 602, and output portion 606 are distinct elements. However, in some embodiments, at least two of input portion 602, inserting portion 602, and output portion 606 may be combined as a unitary element. Further, in some embodiments, at least one of input portion 602, inserting portion 602, and output portion 606 may be implemented as a tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of tangible computer-readable media

Input portion 602 is operable to receive an input data signal 608, which needs to be modulated for transmission. In one embodiment, input data signal 608 is modulated using a known modulation scheme to provide a modulated data signal 610. In one embodiment, input portion 602 receives data symbols signal 212 for modulation with reference to FIG. 2.

Inserting portion 604 is operable to receive a modulated data signal 610 and to insert pilot symbols at non-periodic intervals, non-limiting examples of which include intervals determined with a geometric series, and intervals determined pseudo-randomly. In one embodiment, inserting portion 604 multiplexes modulated data signal 610 with pilot sequence to generate a symbols signal 612, wherein the pilot sequence includes spacings between pilot group k−1 and k is p^{k}, where p is some chosen constant.

Output portion 606 processes symbols signal 612 to provide a tx burst signal 614 ready for transmission. In one embodiment, output portion 606 also inserts a UW pattern at the beginning of each burst to help receiver synchronize with the start of the received burst. In one embodiment, tx burst signal 614 is transmitted through communication channel 106 with reference to FIG. 2.

An example embodiment of a non-periodic pilot sequence for a burst signal is explained with the help of FIG. 7.

FIG. 7 illustrates a non-periodic pilot sequence for a burst signal in accordance with an aspect of the invention.

As illustrated in the figure, a frame 704 is sampled on an x-axis 702, which represents time in seconds. Frame 704 includes a UW 706 and a payload 708.

UW 706 includes a symbol 710, a pilot symbol 712, a symbol 714, a symbol 716, a pilot symbol 718, a symbol 720 and a symbol 720. Note that with reference to FIG. 4, where the pilot symbols in the UW were always periodic, the pilot symbol in UW 706 are non-periodic, i.e., pilot symbol 712 is inserted after one symbol (symbol 710) and pilot symbol 718 is inserted after two symbols (symbol 714 and symbol 716).

Payload 708 includes a symbol 724, a symbol 724, a symbol 726, a symbol 728, a pilot symbol 730, a symbol 732, a symbol 734, a symbol 736, a symbol 738, a symbol 740, a symbol 742, a symbol 744, a symbol 746, a pilot symbol 748, and a symbol 750. Note that with reference to FIG. 4, where the pilot symbols in the payloads were always periodic, the pilots symbols in payload 708 arc at non-periodic intervals, i.e., pilot symbol 730 is inserted after four symbols and pilot symbol 748 is inserted after eight symbols.

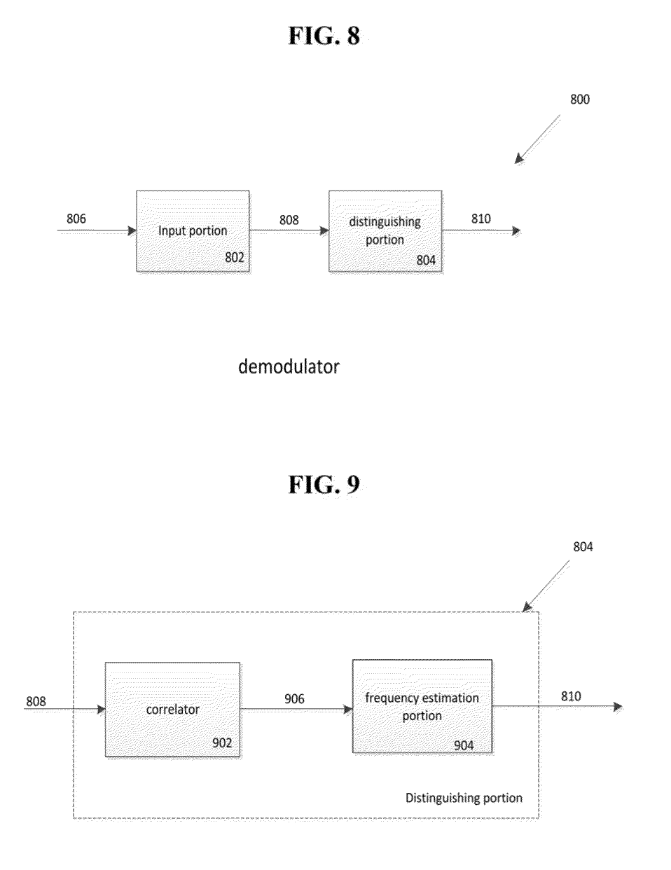

Note that in this example embodiment, pilot symbols arc inserted non-periodically by modulator 600 in accordance with an aspect of the invention. A demodulator, which detects the start of the burst and takes apart non-periodic pilot symbols from the transmitted data to make a frequency estimate, in accordance with an aspect of the invention, is discussed next with the help of FIGS. 8 and 9.

FIG. 8 illustrates a demodulator in accordance with an aspect of the invention.

As illustrated in the figure, a demodulator 800 includes an input portion 802, and a distinguishing portion 804. In this example, input portion 802, and distinguishing portion 804 arc distinct elements. However, in some embodiments, input portion 802 and distinguishing portion 804 may be combined as a unitary clement.

Input portion 802 is operable to receive an rx burst data signal 806 including pilot symbols interspersed therein at non-periodic intervals. In one embodiment, rx burst data signal 806 is received via communication channel 106.

Distinguishing portion 804 is operable to receive a burst data signal 808 including transmitted data and the pilot sequence from input portion 802. Distinguishing portion 804 distinguishes the pilot symbols that arc dispersed at non-periodic intervals from burst data signal 808 and provides an output signal 810, which can be used by a decoder to further decode the received data. In one embodiment, decoder 306 is used. Distinguishing portion 804 is further explained with the help of FIG. 9.

FIG. 9 illustrates an example embodiment of a distinguishing portion in accordance with an aspect of the invention.

As illustrated in the figure, distinguishing portion 804 includes a correlator 902 and a frequency estimation portion 904. In this example, correlator 902 and frequency estimation portion 904 arc distinct elements. However, in some embodiments, correlator 902 and frequency estimation portion 904 may be combined as a unitary element. Further, in some embodiments, at least one of correlator 902 and frequency estimation portion 904 may be implemented as a tangible computer-readable media for carrying or having computer-executable instructions or data structures stored thereon.

Correlator 902 is operable to detect the start of the burst based on UW pattern included in burst data signal 808 and to perform a timing estimate. Correlator 902 performs pattern matching based on the pre-determined symbol structure of UW with the UW received in burst data signal 808. Once a threshold has been met for the correlation operation, correlator 902 performs a timing estimate using a known timing estimation method. Correlator 902 provides a correlated burst signal 906 to frequency estimation portion 904. Correlated burst signal 906 includes the known pilot symbols which were inserted along with the carrier equivalent of the frequency offset.

Frequency estimation portion 904 is operable to estimate the transmission frequency based on information provided in correlated burst signal 906. As discussed with reference to equation (1), frequency estimate is provided by using a ML approach by first computing the DFT of the known pilot symbols after removing modulation. In one embodiment, modulation is removed by multiplying with the complex conjugate of the known transmit signal. Next, the frequency estimate is calculated by finding the frequency that maximizes the magnitude-squared of the DFT output. Other well-known frequency estimation techniques could also be used.

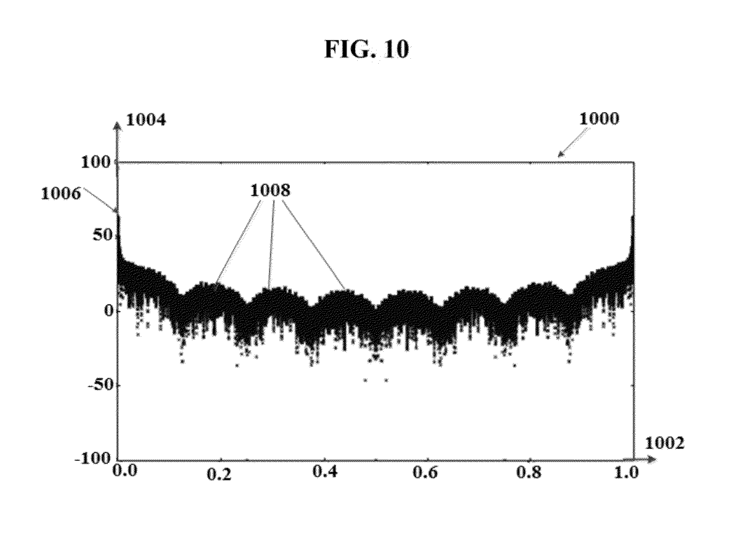

As mentioned above, in one example embodiment, non-periodic pilot sequence is arranged such that the spacing between pilot groups varies as a geometric series. For example, the spacing between pilot group k−1 and k is p^{k}, where p is a chosen constant. A spectrum of the FFT of an example pilot sequence with p=1.5 is shown with the help of FIG. 10.

FIG. 10 illustrates a spectrum 1000 for a non-periodic pilot sequence in accordance with an aspect of the invention.

Spectrum 1000 includes an x-axis 1002, which represents the frequency and a y-axis 1004, which represents magnitude in dB.

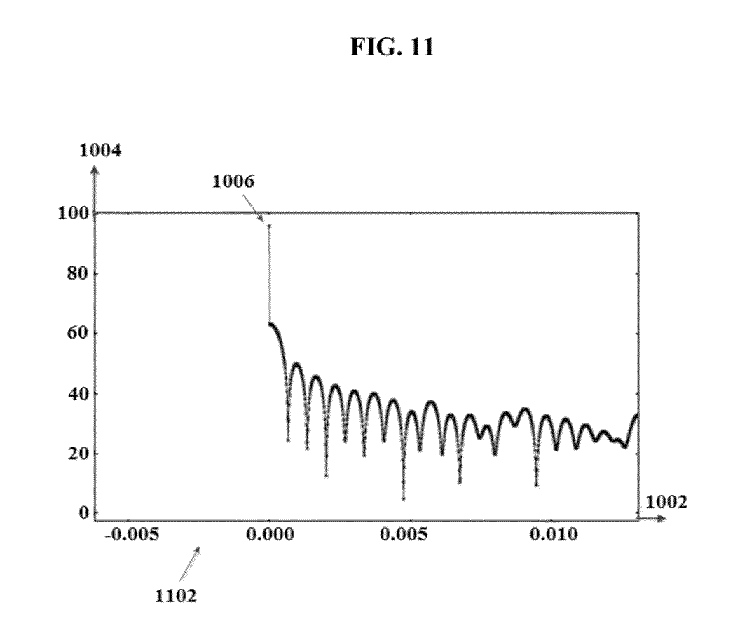

Spectrum 1000 shows the FFT of a non-periodic sequence in accordance with an aspect of the invention. It is obvious from FIG. 10 that there is a clear peak as indicated by a position 1006, where false peaks 1008 are much smaller and fewer as compared to spectrum 500 for a periodic sequence. A closeup of peak 1006 is shown with the help of FIG. 11.

FIG. 11 illustrates a magnified spectrum 1000 in accordance with an aspect of the invention.

As illustrated in the figure, closeup of spectrum 1000 shows a single clear peak at time 1102, as indicated by peak 1006. It is obvious from FIGS. 10-11 that as compared to periodic pilot sequence, a non-periodic pilot sequence prevents false detections of false peaks by providing a single clear peak.

In another embodiment, variable spacing of the first k group of pilots in each group up to some maximum is used followed by pilot groups at periodic intervals. This technique may be useful for longer bursts.

As discussed with reference to FIGS. 6-11, aspects of the invention provide a method of introducing pilot symbols for synchronization that minimizes overhead while allowing for a large frequency uncertainty by inserting the pilot groups non-periodically. This pilot sequence could be used only for carrier phase and frequency estimation, with some other means used for establishing start-of-burst timing (e.g., a separate UW). Alternatively, this pilot sequence could be used for establishing all synchronization, including timing, frequency and phase.

Aspects of the invention presented in this application only discuss burst mode communication systems; however, the method presented here could be applied to continuous mode systems as well. For burst mode communication systems, it is necessary to establish time synchronization by detecting the start timing of the burst, generally followed by a frequency estimate. Typically this synchronization must be established independently for each burst.

For continuous mode systems, time and frequency synchronization once established is usually continuously tracked. However, means are still required to initially establish synchronization.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The example embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A modulator for use in a burst mode communication system having a transmitter and a receiver, the transmitter being operable to transmit output data at a transmission frequency, the output data being based on a stream of information data with pilot symbols interspersed therein, the receiver being operable to receive the output data from the transmitter and to estimate the transmission frequency based on the pilot symbols, said modulator comprising:
an input portion operable to receive the stream of information data;
an inserting portion arranged to receive the stream of information data from said input portion and being operable to insert the pilot symbols into the stream of data at non-periodic intervals to create the output data; and
an output portion operable to provide the output data to the transmitter.

2. The modulator of claim 1, wherein said inserting portion is operable to insert the pilot symbols into the stream of information data at pseudo-random intervals to create the output data.

3. The modulator of claim 1, wherein said inserting portion is operable to insert the pilot symbols into the stream of information data at spaced intervals that vary as a geometric series.

4. A demodulator for use in a burst mode communication system having a transmitter, the transmitter being operable to transmit output data at a transmission frequency, the output data being based on a stream of information data with pilot symbols interspersed therein at non-periodic intervals, said demodulator comprising:
an input portion operable to receive the output data; and
a distinguishing portion arranged to receive the output data from said input portion and being operable to distinguish the pilot symbols that are dispersed at non-periodic intervals from the stream of information data.

5. The modulator of claim 4, wherein said distinguishing portion comprises a correlator.

6. The modulator of claim 5, further comprising an estimating portion operable to estimate the transmission frequency based on the non-periodically interspersed pilot symbols.

7. The modulator of claim 6, wherein said estimating portion is operable to perform a discrete Fourier transform on the non-periodically interspersed pilot symbols.

8. The modulator of claim 4, further comprising an estimating portion operable to estimate the transmission frequency based on the non-periodically interspersed pilot symbols.

9. The modulator of claim 8, wherein said estimating portion is operable to perform a fast Fourier transform on the non-periodically interspersed pilot symbols.

10. A method of communicating in a burst mode communication system having a transmitter and a receiver, the transmitter being operable to transmit output data at a transmission frequency, the output data being based on a stream of information data with pilot symbols interspersed therein, the receiver being operable to receive the output data from the transmitter and to estimate the transmission frequency based on the pilot symbols, said method comprising:
receiving, via an input portion, the stream of information data;
receiving, via an inserting portion, the stream of information data from the input portion;
inserting, via the inserting portion, the pilot symbols into the stream of data at non-periodic intervals to create the output data; and
providing, via output portion, the output data to the transmitter.

11. The method of claim 10, wherein said inserting, via the inserting portion, the pilot symbols into the stream of data at non-periodic intervals to create the output data comprises inserting the pilot symbols into the stream of information data at pseudo-random intervals to create the output data.

12. The method of claim 10, wherein said inserting, via the inserting portion, the pilot symbols into the stream of data at non-periodic intervals to create the output data comprises inserting the pilot symbols into the stream of information data at spaced intervals that vary as a geometric series.

13. A demodulating method in a burst mode communication system having a transmitter, the transmitter being operable to transmit output data at a transmission frequency, the output data being based on a stream of information data with pilot symbols interspersed therein at non-periodic intervals, said method comprising:
receiving, via an input portion, the output data;
receiving, via a distinguishing portion, output data from the input portion; and
distinguishing, via the distinguishing portion, the pilot symbols from the stream of information data.

14. The method of claim 13, wherein said distinguishing, via the distinguishing portion, the pilot symbols from the stream of information data comprises distinguishing, via a correlator, the pilot symbols from the stream of information data.

15. The method of claim 14, further comprising estimating, via an estimating portion, the transmission frequency based on the non-periodically interspersed pilot symbols.

16. The method of claim 15, wherein said estimating, via an estimating portion, the transmission frequency based on the non-periodically interspersed pilot symbols comprises performing a fast Fourier transform on the non-periodically interspersed pilot symbols.

17. The method of claim 13, further comprising estimating, via an estimating portion, the transmission frequency based on the non-periodically interspersed pilot symbols.

18. The method of claim 17, wherein said estimating, via an estimating portion, the transmission frequency based on the non-periodically interspersed pilot symbols comprises performing a fast Fourier transform on the non-periodically interspersed pilot symbols.
